(19) United States
(12) Patent Application Publication
(10) Pub. No.: US 2020/0291711 A1
(43) Pub. Date: Sep. 17, 2020

(54) RAIL ADJUSTER SYSTEM AND METHOD FOR WINDOW REGULATOR SYSTEMS

(71) Applicant: MAGNA CLOSURES INC., Newmarket (CA)

(72) Inventor: John P. McCORKELL, Orillia (CA)

(21) Appl. No.: 16/811,661

(22) Filed: Mar. 6, 2020

Related U.S. Application Data
(60) Provisional application No. 62/818,381, filed on Mar. 14, 2019.

(51) Int. Cl. E05F 15/689; B60J 1/17; B60J 5/04; E05F 11/48

(52) U.S. Cl. CPC E05F 15/689; B60J 1/17; E05Y 2900/55; E05F 11/488; B60J 5/0416

(57) ABSTRACT

A rail adjuster for mounting a rail of a window regulator assembly to an adjacent fixed surface of a closure panel of a vehicle, the rail adjuster comprising: a mount body for mounting to the rail, the mount body defining an adjustment axis; an adjustment body coupled to the mount body and also for mounting to the adjacent fixed surface; and an adjuster portion positioned between the adjacent fixed surface and the adjustment body, the adjuster portion providing said coupled by passing through an aperture of the adjustment body in order to engage with the mount body; wherein operation of the adjuster portion causes a change in an initial length of the rail adjuster to an adjusted length by moving the mount body relative to the adjustment body along the adjustment axis.

### CROSS-REFERENCE TO RELATED APPLICATION

This application claims priority from the benefit of the filing date of U.S. Provisional Patent Application no. 62/818,381 filed on Mar. 14, 2019, entitled “RAIL ADJUSTER SYSTEM AND METHOD FOR WINDOW REGULATOR SYSTEMS”, the contents of which are herein incorporated by reference.

### FIELD

The present disclosure relates to window regulator systems.

### BACKGROUND

Vehicle doors have windows that can be opened and closed. Within the door, there can be a window regulator assembly including a carrier panel, a motor, rails and window regulator lifter or carrier plate assembly which is driven along is respective rail by the motor with associated cabling. There can be several problems, however, with these window regulator assemblies. For example, accurate positioning of the window with respect to the other portions of the vehicle, for example a frame of the door and/or an adjacent roof, can be problematic for more complicated window glass geometries. In particular, adjustment of the window positioning once the window regulator assembly is mounted to the door can be difficult to achieve, without having to disconnect and remount of the window regulator assembly.

Current state of the art window regulator assemblies can require mountings to the door that do not account for adjustment of the glass to frame interface while mounted inside the vehicle.

### SUMMARY

It is an object of the present invention to provide a rail adjustment system and method to obviate or mitigate at least some of the above-presented disadvantages.

A first aspect provided is a rail adjuster for mounting a rail of a window regulator assembly to an adjacent fixed surface of a closure panel of a vehicle, the rail adjuster comprising: a mount body for mounting to the rail, the mount body defining an adjustment axis; an adjustment body coupled to the mount body and also for connecting to the adjacent fixed surface; and an adjuster portion positioned between the adjacent fixed surface and the adjustment body, the adjuster portion providing said coupled by passing through an aperture of the adjustment body in order to engage with the mount body; wherein operation of the adjuster portion causes a change in an initial length of the rail adjuster to an adjusted length by moving the mount body relative to the adjustment body along the adjustment axis.

A second aspect provided is an integrated module as a window regulator assembly including: a carrier panel for mounting to a frame of a closure panel of a vehicle; at least one rail mounted to the carrier panel by one or more rail adjusters, the rail associated with a regulator carriage for coupling to a window of the closure panel, at least one of the rail adjusters having an initial length that can be adjusted to an adjusted length along an adjustment axis of the rail adjuster in order to change an adjustment angle between the rail and the frame, the at least one of the rail adjusters having: a mount body for mounting to the rail, the mount body defining the adjustment axis; an adjustment body coupled to the mount body and also for connecting to an adjacent fixed surface; and an adjuster portion positioned between the adjacent fixed surface and the adjustment body, the adjuster portion providing said coupled by passing through an aperture of the adjustment body in order to engage with the mount body; wherein operation of the adjuster portion causes the change in the initial length of the rail adjuster to the adjusted length by moving the mount body relative to the adjustment body along the adjustment axis.

A third aspect provided is a method for adjusting an adjustment angle between a window of a closure panel and a body of a vehicle, the method comprising the steps of: mounting a rail of a window regulator assembly to an adjacent fixed surface of the closure panel by one or more rail adjusters, the rail adjuster positioned between the rail and the adjacent fixed surface, the window coupled to the rail; and adjusting an initial length of the rail adjuster to an adjusted length in order to vary the adjustment orientation by moving the rail either towards or away from the adjacent fixed surface.

A fourth aspect provided is an adjuster for mounting a component adjacent a fixed surface of a closure panel of a vehicle, the adjuster comprising: a mount body for mounting to the component; an adjustment body coupled to the mount body and also for connecting to the fixed surface; and an adjuster portion coupling the mount body to the adjustment body and configured to move the mount body relative to the adjustment body along an adjustment axis.

A fifth aspect provided is an adjuster for mounting a component adjacent an adjacent fixed surface of a closure panel of a vehicle, the adjuster comprising: a mount body connected to the component; an adjustment body coupled to the mount body and also for connecting to the adjacent fixed surface; and an adjuster portion coupling the mount body to the adjustment body and configured to move the mount body relative to the adjustment body along an adjustment axis.

A sixth aspect provided is an integrated module as a window regulator assembly including a carrier panel for mounting to a frame of a closure panel of a vehicle, at least one rail connected to the carrier panel by one or more rail adjusters, the at least one rail associated with a regulator carriage for coupling to a window of the closure panel, the one or more rail adjusters having an initial length that can be adjusted to an adjusted length along an adjustment axis of the one or more rail adjusters in order to change an adjustment orientation between the rail and the frame. In a related aspect the adjustment of the orientation of the rail changes the orientation of the window relative to at least one of closure panel and the frame of the motor vehicle. In a related aspect, the closure panel may be a frameless closure panel.

In a seventh aspect, provided is a rail adjuster for mounting a rail of a window regulator assembly to an adjacent fixed surface of a closure panel of a vehicle, the rail adjuster including a mount body for mounting to the rail, and an adjustment body coupled to the mount body and also for connecting to the adjacent fixed surface, where the mount body is moveable relative to the adjustment body for adjusting a distance of the rail from the adjacent fixed surface.

In a seventh aspect, provided is a frameless closure panel assembly including a carrier panel having at least one rail adjuster for mounting at least one rail of a window regulator assembly to the carrier panel, the at least one rail adjuster including a mount body for mounting to the at least one rail, and an adjustment body coupled to the mount body and also for connecting to the carrier panel, where the mount body is moveable relative to the adjustment body for adjusting a distance of the at least one rail from the carrier panel.

### BRIEF DESCRIPTION OF THE DRAWINGS

The foregoing and other aspects will now be described by way of example only with reference to the attached drawings, in which:

FIG. 1 is a perspective view of a vehicle;

FIG. 1A illustrates a frameless door assembly, in accordance with one aspect of the disclosure of the vehicle of FIG. 1;

FIG. 2 is a further perspective view of the vehicle of FIG. 1;

FIG. 3 is a side section view of a closure panel of the vehicle of FIG. 2;

FIG. 4 is a component view of a window regulator system of the vehicle shown in FIG. 1;

FIG. 5 is an alternative embodiment of the window regulator system shown in FIG. 3;

FIG. 6 is an exploded view of a rail adjuster shown in FIG. 3;

FIG. 7 is a section view of an assembled rail adjuster of FIG. 6 in an initial length;

FIG. 8 is a section view of the assembled rail adjuster of FIG. 6 in an adjusted length;

FIGS. 9a, b, c show views of the rail adjuster of FIG. 3 in section view, end view, and side view respectively;

FIGS. 10a, b, c show various operational positions of the rail adjuster for adjusting an adjustment angle A of a window of the window regulator assembly of FIG. 3; and

FIG. 11 is an example operation of the rail adjuster of FIG. 3.

### DETAILED DESCRIPTION

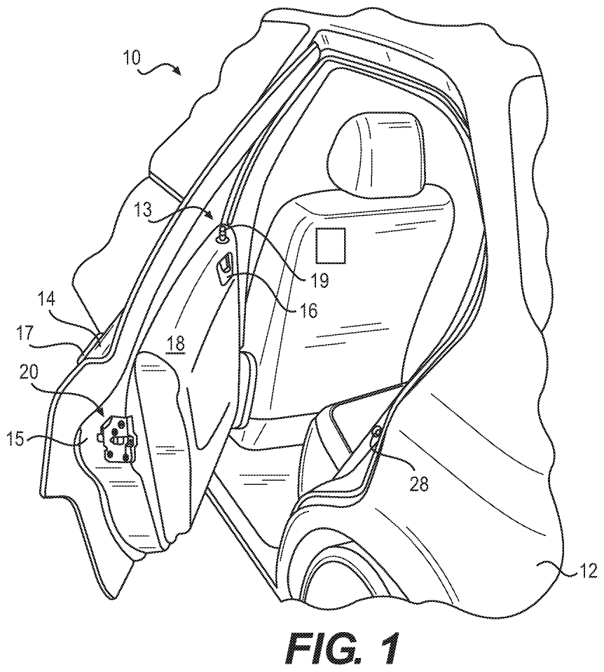

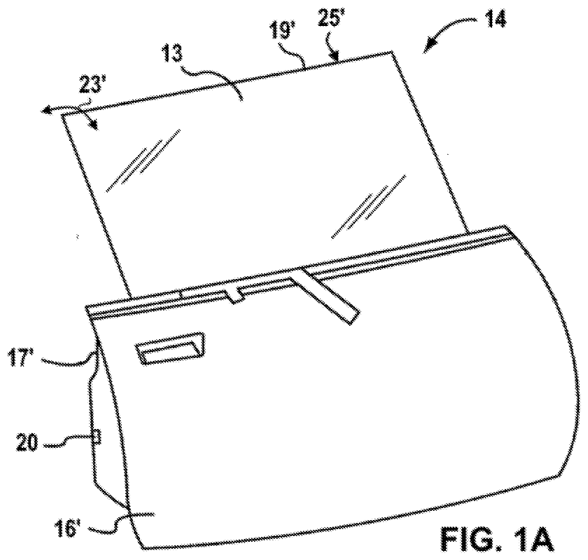

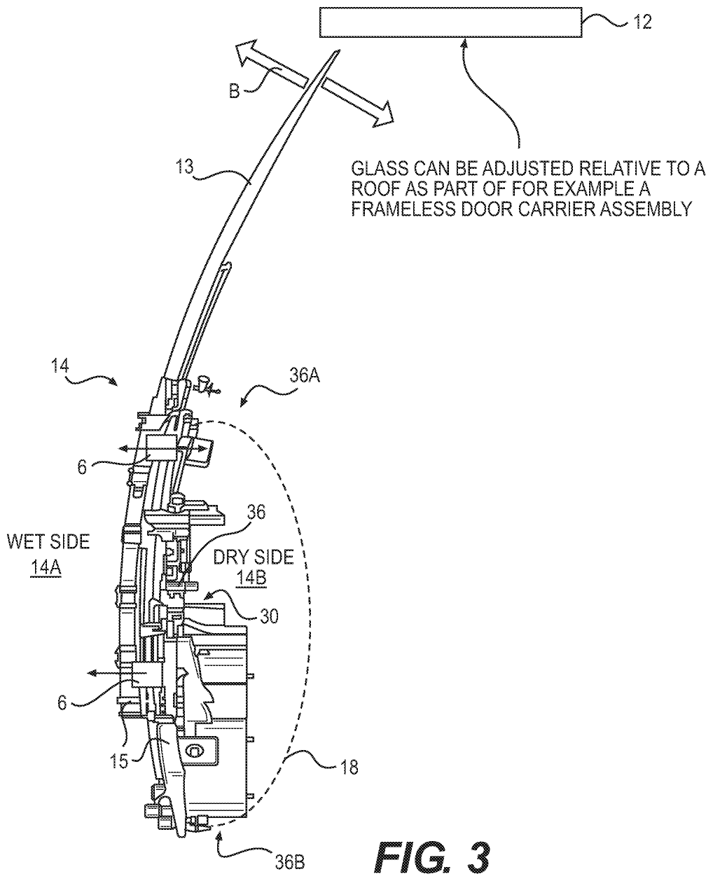

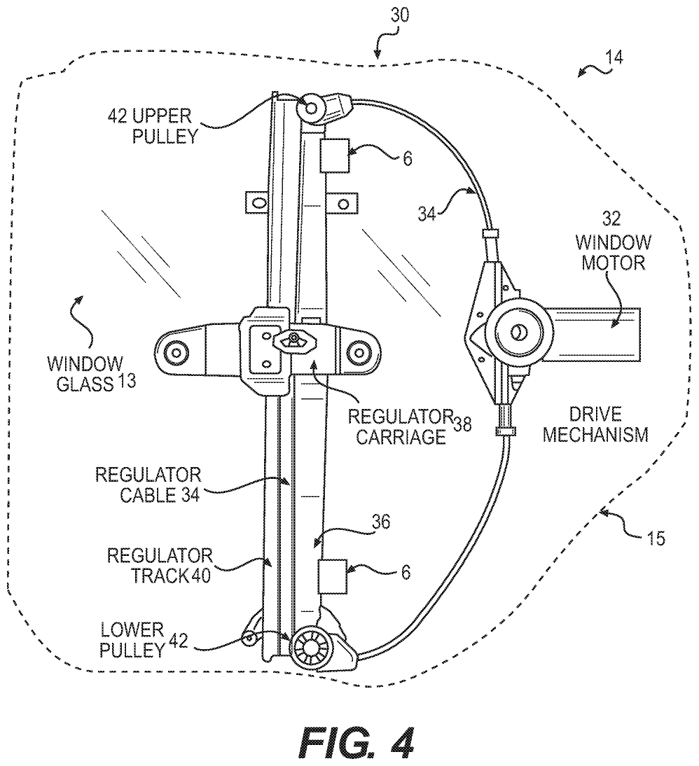

Referring to FIGS. 1 and 2, shown is a vehicle 10 that includes a vehicle body 12 and at least one vehicle door 14 (also referred to as a closure panel 14). The vehicle door 14 includes a latch 20 that is positioned on a frame 15 of the vehicle door 14, such that the latch 20 is releasably engageable with a striker 28 on the vehicle body 12 (e.g. including a roof of the vehicle 10) to releasably hold the vehicle door 14 in a closed position. The frame 15 also supports a window 13 via a window regulator assembly 30 (shown with ghosted view cutout—see FIG. 2—for illustrative purposes only) mounted to the frame 15, as further described below. An outside door handle 17 is provided for opening the latch 20 (i.e. for releasing the latch 20 from the striker 28) to open the vehicle door 14, as well as optionally to operate the window regulator system 30. Further, the vehicle door 14 has an inside control 16 (e.g. door handle, window controls, etc.), with associated optional lock 119, for operating the latch 20 and the window regulator assembly 30, as desired. A door panel 18 is shown providing a cover (e.g. interior panel) over the window regulator assembly 30 (see FIGS. 4 and 5, by example) positioned between the frame 15 and the door panel 18.

For vehicles 10, the closure panel 14 can be referred to as a partition or door, typically hinged, but sometimes attached by other mechanisms such as tracks, in front of an opening which is used for entering and exiting the vehicle 10 interior by people and/or cargo. In terms of vehicles 10, the closure panel 14 may be a driver/passenger door, a lift gate, or it may be some other kind of closure panel 14, such as an upward-swinging vehicle door (i.e. what is sometimes referred to as a gull-wing door) or a conventional type of door that is hinged at a front-facing or back-facing edge of the door, and so allows the door to swing (or slide) away from (or towards) the opening in the body 12 of the vehicle 10. Also contemplated are sliding door embodiments of the closure panel 14 and canopy door embodiments of the closure panel 14, such that sliding doors can be a type of door that open by sliding horizontally or vertically, whereby the door is either mounted on, or suspended from a track that provides for a larger opening. Canopy doors are a type of door that sits on top of the vehicle 10 and lifts up in some way, to provide access for vehicle passengers via the opening (e.g. car canopy, aircraft canopy, etc.). Canopy doors can be connected (e.g. hinged at a defined pivot axis and/or connected for travel along a track) to the body 12 of the vehicle at the front, side or back of the door, as the application permits. It is recognized that the body 12 can be represented as a body panel of the vehicle 10, a frame of the vehicle 10, and/or a combination frame and body panel assembly, as desired.

FIG. 1A illustrates the closure panel 14, or door assembly 14 configured as a frameless door assembly, whereby the window 13 is not bounded by a frame extending from the door panel structure formed for example from outer panel 16′ and/or an inner panel 17′ such that when the window 13 is in the closed position the window 13, including the window edge 19′ may be sealed against the against vehicle body 12 when the door assembly 14 is latched against vehicle body 12 or shut there against. When the window 13 is in the closed position, that is for example extending fully upwards as shown in FIG. 1A and FIG. 1, and the door assembly 14 is released from against vehicle body 12 or open, the window 13 is not bounded by a supporting frame, such that load 23′ applied to the window 13 may result in stress on the window regulator components, different than stresses experienced during opening and closing the window 13′. For example load 23′ may be a result of a user using the window 13 to move the closure panel 14, or load may result when window 13 is urged against vehicle body 12, for example against seals of the vehicle body 12 when the door is in the closed and latch position. Another example of a frameless door assembly is illustrated in commonly owned US patent application No. 20190078366, entitled “Light weight two piece frameless door module with adjustment features”, the entire contents of which are incorporated herein by reference. The teachings herein may allow for adjustment of the window upper edge 25′ relative to the vehicle body 12 such that when the closure panel 14 is closed against the vehicle body 12, the window 13 the position of the window may be properly adjusted such that the stresses of the vehicle body 12 against the window 13 do not cause large deflections and/or damage and/or stress on the window regulator components, for example due to the window 13 being overly oriented inboard towards the vehicle body 12, but rather the window 13 is oriented such that when the door 14 is in a closed position relative to the vehicle body 12 the window 13 abuts into contact with the vehicle body 12 e.g. compressible door seals sufficiently to allow a proper sealing of the glass window 13 against the vehicle body 12 e.g. against compressible seals without causing the window 13 to exert on the window regulator components damaging stress.

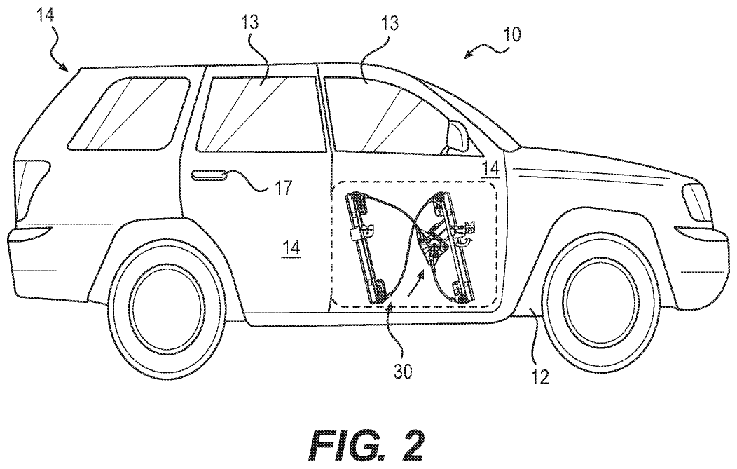

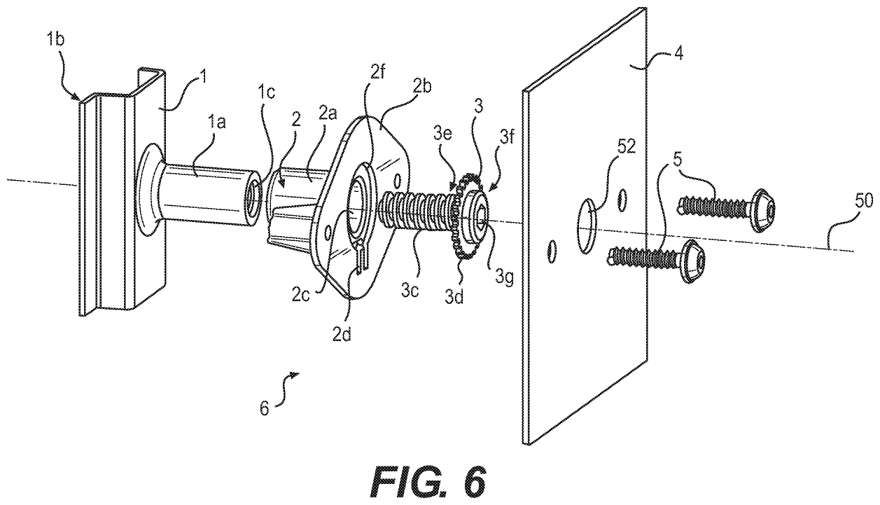

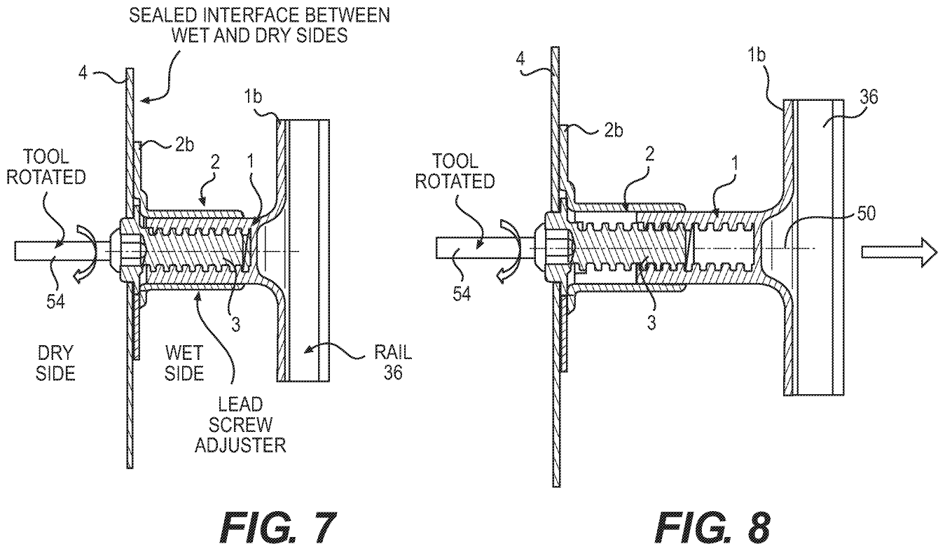

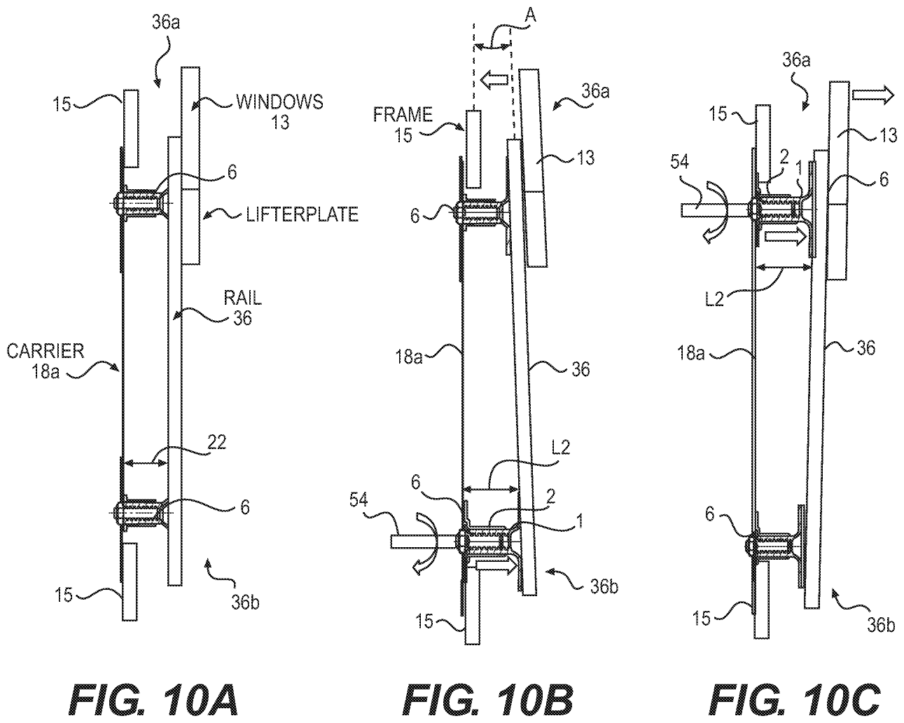

Referring to FIG. 3, shown is a side view of the closure panel 14 with the door panel 18 in ghosted view. The window regulator assembly 30 is mounted to the door frame 15 (or to a carrier 18a mounted to the door frame 1—see FIGS. 10a, b, c). A rail adjuster 6 connects rail(s) 36 directly to the frame 15 (e.g. or as the further embodiment indirectly to the frame 15 via the carrier 18a—see FIGS. 10a, b, c). As such, an angle A between the frame 15 and the rail 36 can be adjusted by operation of the rail adjuster 6, see FIGS. 10a, b, c by example, as further described below. Such angle change may be achieved by adjusting one rail adjuster 6, for example the bottom rail adjuster 6 disposed about bottom regions or portion of the frame 15 and the rail 36 as shown in FIG. 10b where the upper region of rail 36 may be caused to swivel, for example due to a deflection of the frame 15 or carrier panel 18a such as a material deflection of the frame 15 or carrier panel 18a as an example, about the coupling between the rail 36 and the frame 15 at the upper region or portion. The upper adjuster 6 may be provided in lieu as a hinged coupling for allowing such a swivel action in response to the adjustment or operation of the bottom rail adjuster 6, or the upper adjuster 6 may be provided in lieu as a fixed coupling for allowing such a swivel action in response to the adjustment or operation of the bottom rail adjuster 6 through a deformation or deflection of the fixed coupling or the surrounding frame 15, carrier panel 18a, and/or rail 36, as examples. Such orientation changes, such as angular change, may be achieved by adjusting two or more rail adjusters 6, as shown in FIGS. 7 and 8, to provide such adjustments in position of the rails 36, for example by changing the distance of the rail 36 towards or away from the frame 15 at either or both of the adjacent top portions and bottom portions of frame 15 or carrier 18a and rail 36. The mount body 1 is moveable relative to, such as towards or away, the adjustment body 2 for adjusting a distance D (e.g. L1, L2) of the rail 36 from the adjacent fixed surface 4, such as the frame 15 or carrier 18a, for providing such adjustment. As such, the rail 36 is moveable relative to the adjacent fixed surface 4 (e.g. carrier panel 18a or frame 15), such that operation of the adjuster(s) 6 provides for the variable separation distance D between the rail 36 and the adjacent fixed surface 4. As one embodiment, the length (i.e. L1, L2) of the adjuster 6 can be used to represent the separation distance D, as desired. As a result of the change in orientation of the rail(s) 36 relative to the frame 15 or carrier 18a, the orientation of the window pane 13 coupled to the rail(s) 36, for example via the lifter plates 38, relative to the vehicle body 12 results. In the configuration of the closure 14 as a frameless door, the orientation of the window 13 can be adjusted for adjusting the loads 23 of the window 13 against the door seals of the vehicle body 12.

For example, the rail 36 can have a pair of rail adjusters 6, one adjacent to one end 36a and another adjacent to another end 36b of the rail 36. It is also recognized that one rail adjuster 6 can be used, or more than two, in order to adjust the angle A as desired. As can be seen in FIG. 3 by example, adjustment of the angle A by operation of the rail adjusters 6 (i.e. once the window regulator assembly 30 is mounted to the door frame 15 or to the carrier 18a) provides for adjustment B in positioning of the window 13 glass (connected to the rail(s) 36—see FIGS. 4 and 5) with respect to adjacent body 12 and/or frame 15 portions of the vehicle 10. Further, the closure panel 14 has a wet side 14a and a dry side 14b, on either side of the door frame 15 as facilitated via seals (not shown).

As such, it is recognized that the result of any adjustment of angle A provides for the corresponding adjustment B, which preferably provides for variable positioning of the window 13 with respect to the body 12 of the vehicle and/or the frame 15 of the closure panel 14. It is this variable positioning capability of the rail adjuster(s) 6 that can be used to accommodate for configuration/geometrical considerations of the window 13 and/or body 12 and/or frame 15 and/or carrier panel 18a, in terms of ultimate fit/operation of the window 13 (by the window regulator assembly 30) once the window 13 is installed and adjusted for operation in the closure panel 14.

Referring to FIG. 4, the window regulator assembly 30 is for moving the vehicle window 13 up and down, i.e. in and out of an enclosure provided between the frame 15 and the door panel 18. The window regulator assembly 30 can include a drive motor and drive mechanism (e.g. gearing) 32 connected to a set of drive cables 34, one or more rails 36 for mounting on the frame 15 (or on an intervening carrier panel 18a as desired—see FIG. 10a), a regulator carriage 38 connected to the window 13 and mounted on the rail 36 for riding along a track 40, and one or more pulleys 42 (e.g. upper pulley and lower pulley) for effecting changes in direction of the drive cables 34. In operation of the window regulator assembly 30, the drive motor 32 causes movement of the drive cables 34 which in turn propels the regulator carriage 38 towards one end or the other end of the rail 36, depending upon the rotational direction of the drive motor 32 (e.g. as controlled by the door controls 16,17). It is recognized that the rails 36 can be mounted on the carrier panel 18a by the rail adjusters 6 (providing an integrated rail module as the window regulator system 30) that is itself mounted to the frame 15 by connectors 15a (see FIG. 5).

Alternatively, the rails 36 of the window regulator system 30 can be mounted directly to the frame 15 via the rail adjuster(s) 6 without the need for the intervening carrier panel 18a, providing for a piece-wise assembly of the window regulator system 30 directly to the frame 15, see FIG. 4 with the frame 15 shown in ghosted view. It is also recognized that some of the components (e.g. 32, 34, 36, 38, 42) of the window regulator assembly 30 can be mounted to the carrier panel 18a and others of the components (e.g. remaining 32, 34, 36, 38, 42) could be mounted directly to the frame 15 without the intervening carrier panel 18a. In a preferred embodiment, the window regulator assembly 30 is mounted to the carrier panel 18a via a pair of rail adjusters 6 (see FIG. 10a) and provided as an integrated door module for fastening as an integrated unit to the frame 15 of the closure panel 14.

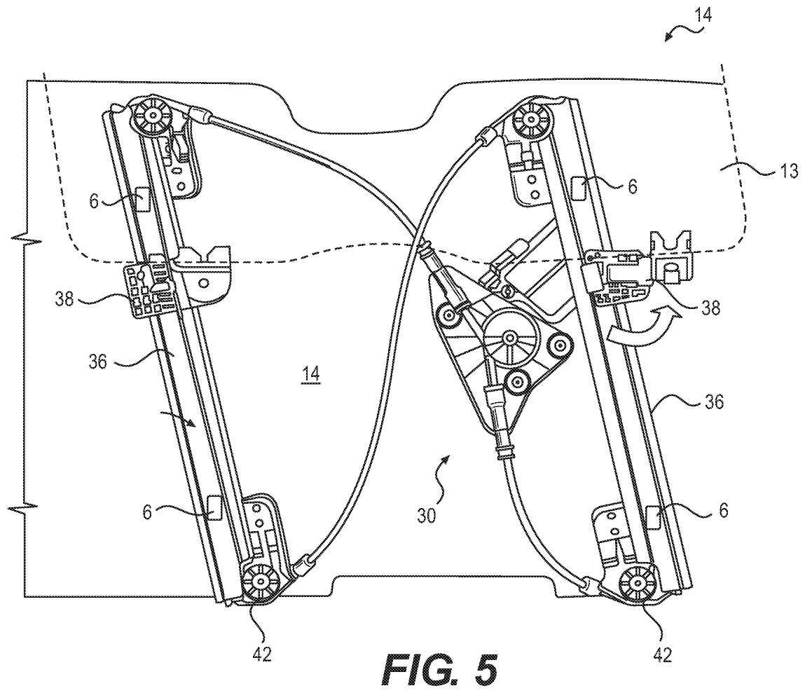

Referring to FIG. 6, shown is the rail adjuster 6 in exploded view. The rail adjuster 6 has a mount body 1 for fixedly mounting the rail adjuster 6 to the rail 36 (see FIG. 7). The mount body 1 can have a bracket portion 1b for mounting onto the rail 36 (e.g. via mechanical fasteners, welding, adhesives, as desired). The mount body 1 defines an adjustment axis 50, along which an adjustment body 2 is slideably mounted onto the mount body 1, e.g. the adjustment body 2 having a tube 2a being received on a stem 1a of the mount body 1. The adjustment body 2 has a flange portion 2b for mounting the rail adjuster 6 (e.g. via fasteners 5) to an adjacent fixed surface 4 (e.g. the frame 15 or the carrier 18b panel).

Alternatively, the adjacent fixed surface 4 can be the rail 36 and the mount body 1 can be used to attach the adjuster 6 to the carrier panel 18a (or the frame 15), as desired.

Alternatively, the rail adjuster 6 can be used for mounting a component (e.g. a first component such as a rail 36, a carrier panel 18a, a frame 15, etc.) adjacent an adjacent fixed surface 4 (e.g. a second component opposite to and complimentary to the first component such as a carrier panel 18a, a rail 36 or a frame 15) of a closure panel 14 of a vehicle 10, the rail adjuster 6 comprising: a mount body 1 connected to the component (e.g. rail 36); an adjustment body 2 coupled to the mount body 1 and also for connecting to the adjacent fixed surface (e.g. the carrier panel 18a); and an adjuster portion 3 coupling the mount body 1 to the adjustment body 2 and configured to move the mount body 1 relative to the adjustment body 2 along an adjustment axis 50.

Further, the adjustment body 2 can be integrally formed with the adjacent surface 4, for example in an embodiment where the adjacent fixed surface 4 is the carrier panel 18a formed from a plastic material injected into a mould, wherein the mould may include features to shape the adjustment body 2. In this manner, fasteners 5 would not be needed to connect the adjustment body 2 to the adjacent fixed surface 4. The carrier panel 18a includes a dry surface or dry side facing the dry side 14b, and an opposite wet side or wet surface facing the wet side 14a when installed with the closure 14. In a possible configuration, the adjuster portion 6 includes an interface accessible on the dry side of the carrier 18a for operating the adjuster portion 6. The interface may be accessible through an opening provided in the inner panel 17′ after the carrier 18a has been mounted to the inner panel 17′. Such an interface may be for example the head 3f of the adjuster portion 3 which may include a tool engaging portion 3g as described herein, or may be a knob directly manipulated by the fingers of a human or robotic installer.

The rail adjuster 6 also has an adjuster portion 3 (e.g. threaded fastener) for coupling the mount body 1 to the adjustment body 2, such that operation of the adjuster portion 3 causes the adjustment body 2 to be variably positioned along the adjustment axis 50 (e.g. operation of the adjuster portion 3 causes the adjustment body 2 to be displaced along the adjustment axis 50 relative to the mount body 1). As an example embodiment of the adjuster portion 3, as a threaded fastener, the stem 1a has threads 1c that engage with threads 3c of the adjuster portion 3. The adjustment body 2 can have an aperture 2c though which the adjuster portion 3 can be received/inserted, so as to engage the threads 3c with the threads 1c, for example. The aperature 2c may be sealed, for example by used of a gasket disposed between the head 3f and a surface of the adjacent fixed surface 4. As such, the adjuster portion 3 is used to couple the adjustment body 2 with the mount body 1 along the adjustment axis 50. As a further embodiment, the adjuster portion 3 can have one or more tabs 3d (e.g. teeth) about a periphery 3e of a head 3f, which can engage with a resilient element 2d of the adjustment body 2, thereby providing for a locking mechanism for fixing a selected position of the adjustment body 2 along the adjustment axis 50. The locking mechanism may be self-locking, that is upon adjustment of the adjuster 6, no further action is required to lock the adjustment body 2 in a position relative to the mount body 1, and any input load e.g. along the adjustment axis applied to one of the adjustment body 2 or the mount body 1 may not cause the locked state of the adjuster to change to prevent the distance between the rail 36 and frame 15 or carrier panel 18a to remain fixed. In another or combined configuration, the screw angles of the first threads (3c) with the second threads (1c) may be self-locking, for example non-backdriveable, which may operate in conjunction with the locking mechanism consisting of the tabs 3d. In one possible configuration, the self-locking configuration of the threads 3c, 1c may only be provided.

Referring again to FIG. 6, the head 3f can be positioned and retained between the flange portion 2b and the adjacent fixed surface 4, once the adjacent fixed surface 4 is connected (or otherwise formed) to the adjustment body 2 via the flange portion 2b (e.g. using the fasteners 5). For example, the head 3f can be received within a receptacle 2f of the adjustment body 2. Further, the head 3f of the adjuster portion 3 can have a tool engaging portion 3g (e.g. hex-shaped receptacle as shown, or other embodiment not shown—hex head, screwdriver slot, etc.), which is accessed via an aperture 52 in the adjacent fixed surface 4 of the closure panel 14. Tool engaging portion 3g may be accessible from the dry side 14b, e.g. between the frame 15 and the door panel 18, facilitating easy maintenance and adjustment subsequent to carrier 18a being installed to the closure panel 14, in accordance with one example.

Referring to FIG. 7, shown is a cross sectional view of an assembled rail adjuster 6. As shown in FIG. 7 by example, engagement of the tool engaging portion 3g with a tool 54 can be done by an installer in order to change the position of the adjustment body 2 with respect to the mount body 1. For example, rotation of the adjuster portion 3 by rotation of the tool 54 about the adjustment axis 50, in one direction, can cause relative movement of the mount body 1 away from the adjustment body 2 (see FIG. 8) and thus change the adjustment angle A, see FIGS. 10a, b, c, of the rail 36 with respect to the frame 15 and/or the body 12. It is appreciated that rotation of the adjuster portion 3 by rotation of the tool 54 about the adjustment axis 50, in the other direction (opposite to the one direction), can cause relative movement of the mount body 1 towards the adjustment body 2 (see FIG. 8) and thus change the orientation, for example the adjustment angle A, see FIGS. 10a, b, c, of the rail 36 with respect to the frame 15 and/or the body 12.

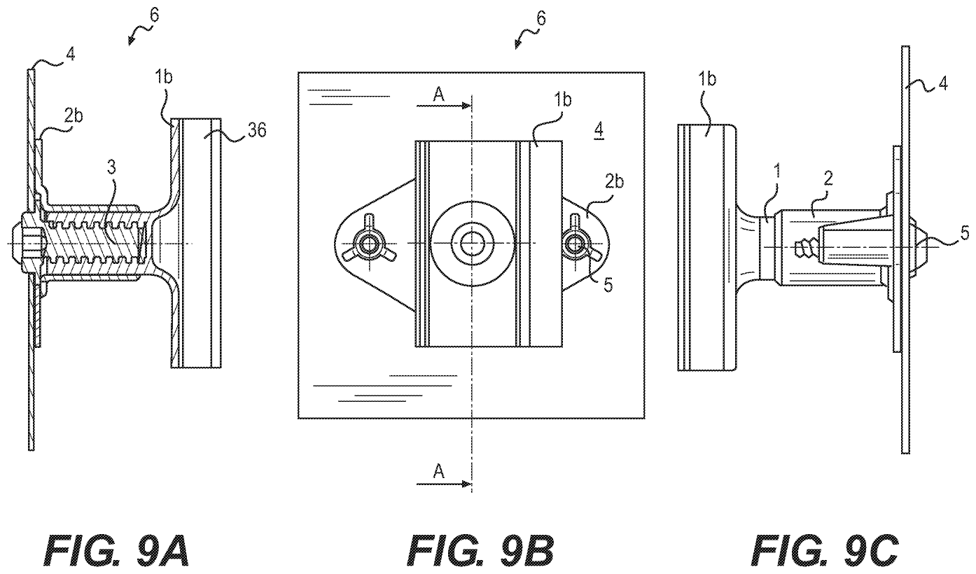

FIG. 9a shows a section view of the rail adjuster 6 using a section A-A of FIG. 9b. FIG. 9c shows a side view of the rail adjuster 6 once assembled.

Referring to FIG. 10a, shown is an example assembly of the rail 36 (of the window regulator assembly 30—see FIG. 4) to the frame 15 of the closure panel 14, for example via the carrier 18a. The rail 36 is mounted to the carrier 18a (one version of the adjacent fixed surface 4 of the closure panel 14) at the one end 36a by a first rail adjuster 6 and at the other end 36b by a second rail adjuster 6, thus providing an initial length L1 of the rail adjuster 6, such that the pair of rail adjusters 6 are spaced apart from one another laterally to the adjustment axes 50.

In FIG. 10b, upon operation of the second rail adjuster 6 (via the tool 54), causes the mount body 1 to move away from (relatively) the adjustment body 2, thus changing the initial length L1 to an adjusted length L2 resulting in adjusting the adjustment angle A of the window 13 with respect to the frame 15, which in this case moves the one end 36a to move closer to the frame 15. With the rail adjuster 6 having a length L1, the rail 36 is at a first distance away from the frame 15 or carrier panel 18a.

Alternatively, or in addition, as shown in FIG. 10c, upon operation of the first rail adjuster 6 (via the tool 54), causes the mount body 1 to move away from (relatively) the adjustment body 2, thus changing the initial length L1 to the adjusted length L2 resulting in adjusting the adjustment angle A of the window 13 with respect to the frame 15, which in this case cases the other end 36b to move closer to the frame 15. With the rail adjuster 6 having a length L2, the rail 36 is at a second distance away from the frame 15 or carrier panel 18a which shown in comparison between FIGS. 10a and 10b the second distance is greater than the first distance. It is also recognized that the initial length L1 can be greater than the adjusted length L2.

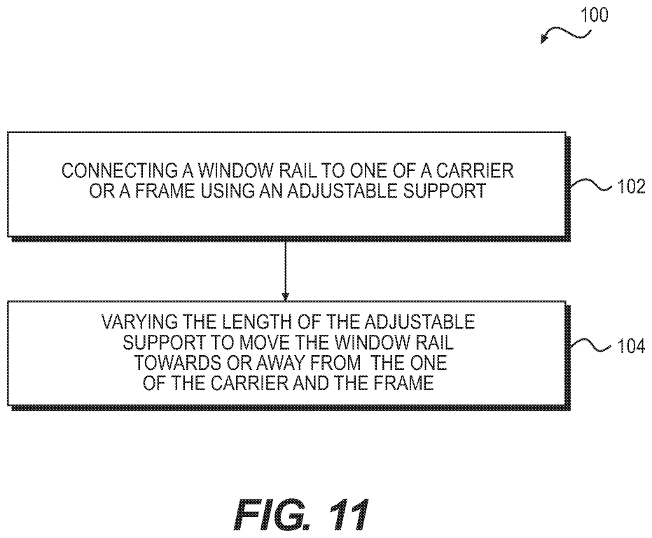

Referring to FIG. 11, shown is a method 100 of operation of the rail adjuster(s) 6. At step 102, the rail of the window regulator assembly 30 is mounted to the fixed adjacent surface 4 (e.g. the frame 15 and/or the carrier 18a) by one or more rail adjusters 6. At step 104, the initial length L1 of the rail adjuster 6 can be adjusted to the adjusted length L2 in order to move the rail 36 (and attached window 13) either away from or towards the adjacent fixe surface 4.

While the above description constitutes a plurality of embodiments, it will be appreciated that the present disclosure is susceptible to further modification and change without departing from the fair meaning of the accompanying claims.

We claim:

1. A rail adjuster (6) for mounting a rail (36) of a window regulator assembly (30) to an adjacent fixed surface (4) of a closure panel (14) of a vehicle (10), the rail adjuster comprising:
a mount body (1) for mounting to the rail; and
an adjustment body (2) coupled to the mount body and also for connecting to the adjacent fixed surface;
wherein the mount body is moveable relative to the adjustment body for adjusting a position of the rail from the adjacent fixed surface.

2. The rail adjuster of claim 1, wherein the rail adjuster further comprises:
an adjuster portion (3) providing said coupled;
wherein the mount body defines an adjustment axis;
wherein operation of the adjuster portion causes a change in an initial length (L1) of the rail adjuster to an adjusted length (L2) by moving the mount body relative to the adjustment body along the adjustment axis.

3. The rail adjuster of claim 2, wherein the adjuster portion (3) is positioned between the adjacent fixed surface and the adjustment body, the adjuster portion providing said coupled by passing through an aperture (2c) of the adjustment body in order to engage with the mount body.

4. The rail adjuster of claim 3, wherein the adjuster portion has first threads (3c) for providing said engage with second threads (1c) of the mount body, such that said engage provides for said coupled.

5. The rail adjuster of claim 4, wherein the adjuster portion is a threaded fastener and the mount body has a stem (1a) containing the second threads.

6. The rail adjuster of claim 2, wherein the adjuster portion (3) is self-locking.

7. The rail adjuster of claim 2, wherein the adjacent fixed surface is a carrier (18a) for coupling to a frame (15) of the closure panel, the carrier having a dry side and an opposite wet side, the adjuster portion comprising an interface accessible on the dry side of the carrier for operating the adjuster portion.

8. The rail adjuster of claim 2, wherein the adjacent fixed surface is a carrier (18a) for coupling to a frame (15) of the closure panel, wherein operation of the adjuster portion changes an orientation of the rail (36) relative to the carrier.

9. The rail adjuster of claim 8, further comprising a head (3f) of the adjuster portion, the head having a tool engaging portion (3g) for engaging with a tool in order to provide said operation.

10. The rail adjuster of claim 9, wherein the head includes a plurality of tabs (3d) for engaging with a resilient element (2) of the adjustment body in order to maintain the adjusted length.

11. The rail adjuster of claim 10, wherein the head is received in a receptacle (2f) of the adjustment body (2).

12. The rail adjuster of claim 1, wherein the adjuster body is integrally formed with the adjacent fixed surface.

13. An integrated module as a window regulator assembly (30) comprising:
a carrier panel (18a) for mounting to a frame (15) of a closure panel (14) of a vehicle (10);
at least one rail (36) connected to the carrier panel by one or more rail adjusters (36), the rail associated with a regulator carriage (38) for coupling to a window (13) of the closure panel, the at least one of the one or more rail adjusters having an initial length (L1) that can be adjusted to an adjusted length (L2) along an adjustment axis (50) of the one or more rail adjusters in order to change an adjustment orientation between the rail and the frame.

14. The integrated module of claim 13, wherein the one or more rail adjusters comprises:
a mount body (1) for mounting to the rail;
an adjustment body (2) coupled to the mount body and also for connecting to an adjacent fixed surface; and
wherein the mount body is moveable relative to the adjustment body for adjusting the orientation between the rail and the frame.

15. The integrated module of claim 14, further comprising:
an adjuster portion (3) positioned between the adjacent fixed surface and the adjustment body, the adjuster portion providing said coupled by passing through an aperture (2c) of the adjustment body in order to engage with the mount body;
wherein operation of the adjuster portion causes a change in an initial length of the rail adjuster to the adjusted length by moving the mount body relative to the adjustment body along the adjustment axis.

16. The integrated module of claim 15, wherein the carrier panel comprises a dry side and an opposite wet side, the adjuster portion comprising an interface accessible on the dry side of the carrier panel for operating the adjuster portion.

17. The integrated module of claim 15, wherein the adjuster portion has first threads (3c) for providing said engage with second threads (1c) of the mount body, such that said engage provides for said coupled, wherein the adjuster portion is a threaded fastener and the mount body has a stem (1a) containing the second threads.

18. The integrated module of claim 15, wherein the at least one rail is connected to the carrier panel by one or more rail adjusters provided at a lower portion of the at least one rail, wherein operation of the adjuster portion changes an orientation of the rail (36) relative to the carrier panel for changing a position of the window.

19. The integrated module of claim 18, wherein the closure panel is a frameless closure panel.

20. An adjuster (6) for mounting a component (36) adjacent a fixed surface (4) of a vehicle (10), the adjuster comprising:
a mount body (1) for mounting to the component;
an adjustment body (2) coupled to the mount body and also for connecting to the fixed surface; and
an adjuster portion coupling the mount body to the adjustment body and configured to move the mount body relative to the adjustment body;
wherein the fixed surface includes a first side and an opposite second side, the mount body provided on one of the first side and the opposite second side, the adjustment body comprising an aperture (52) for facilitating adjustment of the adjuster on the other one of the first side and the opposite second side.
